(19) United States
(12) Patent Application Publication
(10) Pub. No.: US 2007/0220611 A1
(43) Pub. Date: Sep. 20, 2007

(54) METHODS AND SYSTEMS FOR SHARING OR PRESENTING MEMBER INFORMATION

(76) Inventors: Ari Socolow, New York, NY (US); Igor Gershteyn, Jamaica, NY (US)

Correspondence Address: FOX ROTHSCHILD LLP;PRINCETON PIKE CORPORATE CENTER, 997 LENOX DRIVE, BUILDING #3, LAWRENCEVILLE, NJ, 08648, US

(21) Appl. No.: 11/674,795

(22) Filed: Feb. 14, 2007

Related U.S. Application Data
(60) Provisional application No. 60/787,757, filed on Apr. 3, 2006.
(60) Provisional application No. 60/774,207, filed on Feb. 17, 2006.

(51) Int. Cl. H04L 9/32; H04N 7/16; G06F 17/30

(52) U.S. Cl. 726/26; 705/74; 726/30; 726/27

(57) ABSTRACT

Methods of sharing or presenting members' information without identifying the members are provided. The method comprises receiving a request from a requesting party wherein the requesting party specifies at least one characteristic of members it seeks to target or search in the request; generating a list of members that match the specified characteristic or characteristics in response to the request; substituting information related to members on the list with an anonymous identifier and providing such identifier to the requesting party. Preferably, each member is assigned a unique identifier. The method for supplementing information collected from different organizations is also provided. Additionally, the system and computer program for carrying out these methods are disclosed.

### CROSS-REFERENCE TO RELATED APPLICATIONS

This application claims the benefit of U.S. Provisional Application Ser. No. 60/787,757, filed on Feb. 17, 2006, and U.S. Provisional Application Ser. No. 60/774,207, filed on Apr. 7, 2006, both of which incorporated herein by reference in their entirety.

### FIELD OF THE INVENTION

This invention relates to methods of sharing information. More particularly, it relates to methods of sharing or presenting member information without identifying the members.

### BACKGROUND OF THE INVENTION

Organizations possess unique information regarding their members and are regularly presented with requests concerning these members. Requesting parties can be of several different sources such as advertisers, marketers and governmental agencies. For example, disclosure of certain information concerning the members can offer organizations opportunities to generate additional revenue from advertisers or can be required in order to safeguard the public good. However, disclosure of any information that would reveal the identity of the member can alienate members, violate public policy, and contravene laws designed to safeguard identity and security. The challenge of balancing these objectives is especially great when an organization, such as a wireless telecom carrier, possess detailed information on location of its members and receives a request for information that may include disclosing this information with or without information from a member profile.

Accordingly, there is a need for a method that enables an organization to share or to present information about its members without compromising members' security or privacy.

### SUMMARY OF THE INVENTION

In one aspect, a method for sharing or presenting information regarding members is provided. The method comprises receiving a request from a requesting party wherein the requesting party specifies at least one characteristic of members it seeks to target or search in the request; generating a list of members that match the specified characteristic or characteristics in response to the request; substituting information related to members on the list with an anonymous identifier and providing such identifier to the requesting party. Preferably, each member is assigned a unique identifier.

The method may also comprise a step of destroying the encrypted information after the requesting party indicates that a project is over or after a set time period or a step of receiving instructions to perform a further action associated with at least some members on the list.

In some embodiments, the at least one characteristic comprises a location. When the specified characteristics comprise a location and at least one other characteristic, the method comprises generating a list of member that match a real-time location specified by the requesting party; generating a list of members based on one or more other characteristics specified by the requesting party; and intersecting the lists generated based on the location and other characteristics.

In some embodiments, the method may include the steps of generating a list comprising a plurality of random last names and random first names wherein the number of random last names and the number of random first names equals the number of the members on the list; and replacing or supplementing encrypted information with one random last name and one random first name wherein a unique pair of random last name and random first name are only used once.

The method in this aspect may also comprise the additional steps of receiving a one-way encryption key; applying the one-way encryption key to hash information related to at least some of the members on the list; and causing the requesting party to receive hashed information. Alternatively, the additional steps may comprise receiving a one-way encryption key and a first hashed information; applying the one-way encryption key to generate second hashed information related to at least some of the members on the list; intersecting the first and the second hashed information; and causing the requesting party to receive information related to members included into the first and the second hashed information, if any.

In another aspect, a method for sharing information between a first organization and at least one second organization each having at least one member is disclosed. The method comprises a first organization generating first encrypted information utilizing a one-way encryption key; the first organization sharing the one-way key with at least one second organization; at least one second organization generating at least second encrypted information utilizing the one-way encryption key; and comparing the first encrypted information and the second encrypted information.

In yet another aspect, a system for sharing information regarding members is provided. Such system comprises a bus system; a memory connected to the bus system wherein the memory includes a set of instructions; and a processor connected to the bus system, wherein the processor executes the set of instructions stored in memory to perform the steps of methods described above.

Additionally, a computer-readable medium is provided. The computer-readable medium contains computer instructions, which, when executed, carry out methods for sharing information regarding members, as described above.

### BRIEF DESCRIPTION OF THE DRAWINGS

FIG. 1 illustrates an architecture suitable for the methods disclosed herein.

FIG. 2 is a flow of requests diagram in the methods disclosed.

FIG. 3 illustrates a flow chart of steps performed by a central platform to generate VIPNs.

FIG. 4 is illustrates flow of requests utilized during when combining information from different organizations.

FIG. 5 illustrates a system suitable for disclosed methods of VIPN cross-referencing.

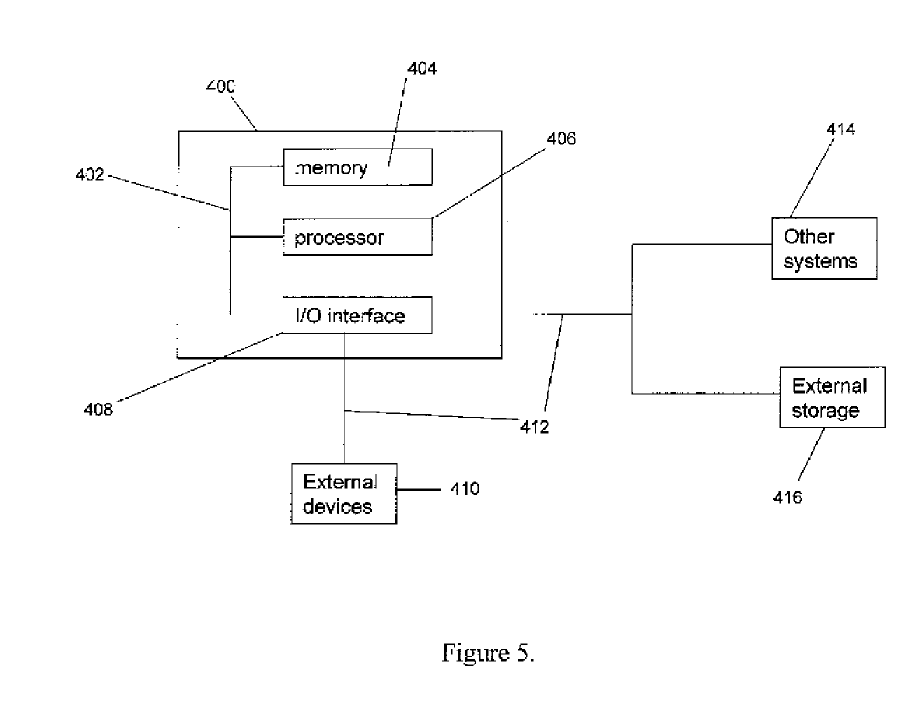

### DETAILED DESCRIPTION

The term “organization” refers to an entity that may, by law, by policy, or by privilege, maintain sensitive as well as non-sensitive information about its members, i.e. individual or household who join the organization because of the organizational purpose, or use of services or products provided by the organization. This information may be collected by a variety of different methods. For example, this information may be provided by the members themselves when subscribing for the services offered by the organization. Alternatively, this information may be obtained from other organizations such as, for example, during the background check of a potential member. Organizations may keep this information in Member Profiles typically stored in storage systems that are preferably easily searchable. Such storage systems are well known in the art and are commercially available from, for example, Oracle Corporation, of Redwood Shores, Calif.

An organization may possess several types of information. For example, the organization may maintain information that may identify its members, i.e., identifying information, about its members. Such information includes, but is not limited to, name, address, phone number, social security number, date of birth or any other information that may identify a member. An organization may also possess non-identifying information about its members, i.e., information that does not identify an organization's members. Such information gathered by an organization may include, but is not limited to, gender, income, profession, interests or marital status. Some organizations, by virtue of their line of business, will also maintain unique non-identifying information that is related to the types of services the organization offers in a Member Profile. Information that is commonly found in a Member Profile, therefore, may vary from organization to organization depending on the industry in which the organization operates. For example, an airline or hotel chain may record the destinations traveled to by members, an energy transmission company may record members' usage patterns, a credit card company may record members' spending patterns, and a telecom carrier may record the members' calling patterns. Wireless telecom carriers are in a unique position to know and to record their members' real-time locations or patterns of location using one of several methods of location determination.

A Member Profile or series thereof provides an instrument for an organization to record and to know the needs and requirements of each member, thereby making an appropriate service offering related to its own service to each member. In addition, the data maintained in Member Profiles may be used by an organization to derive revenue or to serve the greater public good. For example, a commercial entity may seek to forward some advertising or marketing-related materials to people who fit some specific specifications or characteristics. The organization may provide to the requesting party a list of its members who fit such specifications or characteristics. Alternatively, a governmental organization, for example, may need to notify its members in a certain location about an existing emergency. In providing such access, an organization must meet not only its own internal requirements, but also those imposed on it by law and by the public at large. These requirements will often prevent it from disclosing identifying information about its members to a requesting party.

Accordingly, a computer implemented method for sharing information between an organization and a requesting party regarding the organization's members is provided. The method comprises receiving a request from a requesting party wherein the requesting party specifies at least one members' characteristic in the request, generating a list of members that match the at least one specified characteristic in response to the request, encrypting identifying information related to members on the list; and providing the encrypted information to the requesting party.

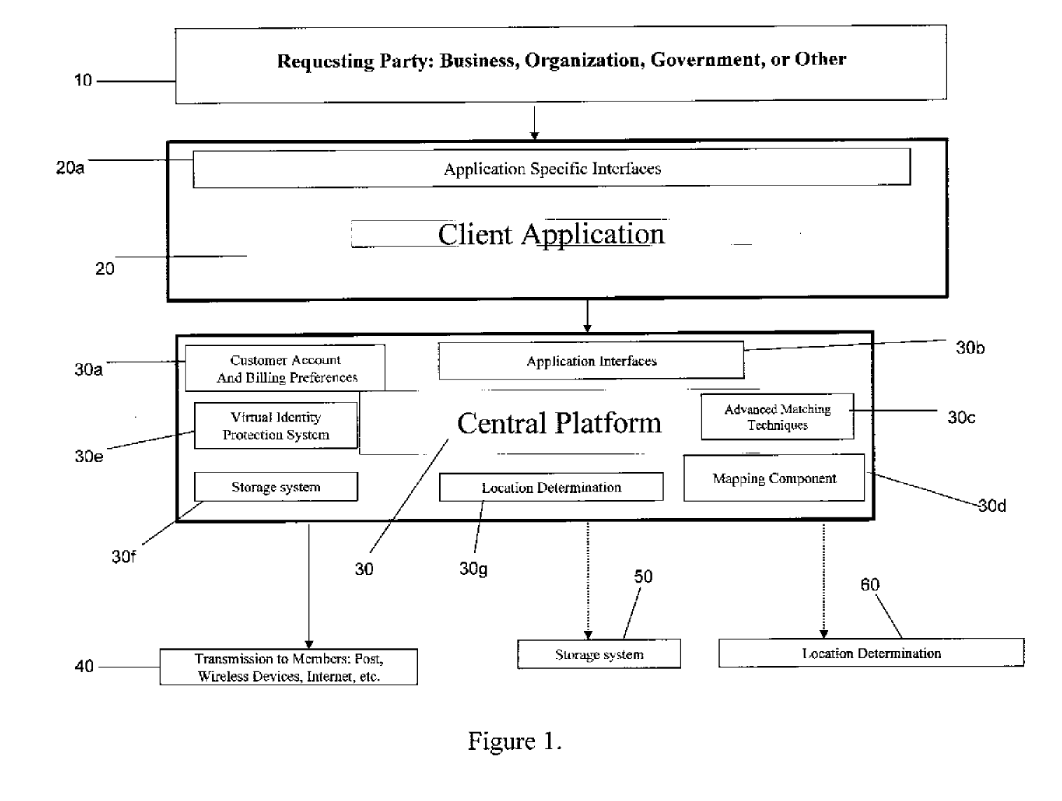

An example of a functional diagram suitable for the methods disclosed here is illustrated in FIG. 1. A requesting party 10 such as, for example, an individual, a business, organization, or a governmental organization, accesses the client application 20. Client application 20 may comprise various application-specific interfaces 20a or other applications.

The client application 20 may reside on the organization's own network or may be hosted by a service partner designed to provide an application service relying on the sharing of information. The client application 20 may include interfaces that provide the requesting party 10 with access to the application 20. The connection to the application may be made through any known communication network. Suitable communication networks include, but are not limited to, the internet, an intranet, a LAN network, a WAN network, a wireless telephony network, or a virtual private network, among others. Alternatively, the client application 20 may reside on the requesting party's computer network through any communication network described above.

The client application 20 is in communication with a central platform 30 that resides on the organization's network. Many different functions may run on the central platform 30. Suitable applications include, but are not limited to, customer account and billing preferences 30a, client application interfaces 30b, advanced matching techniques 30c, mapping components 30d, virtual identity protection system 30e, storage system 30f, location determination 30g, and combinations thereof. In alternative embodiments, in addition to or instead of internal location determination 30g and storage system 30f, an external storage system 50, an external location determination system 60, or combinations thereof may reside outside the central platform 30 and be connected over any communication network.

The central platform 30 may be connected to wired and wireless communication devices 40 through a communication network. Such communication devices may include, but are not limited to, cell phones, phones, PDAs, and computers. This connection allows the organization to transmit information and materials on behalf of the requesting party to its members as necessary. The organization may also contact its members by regular post mail or by email.

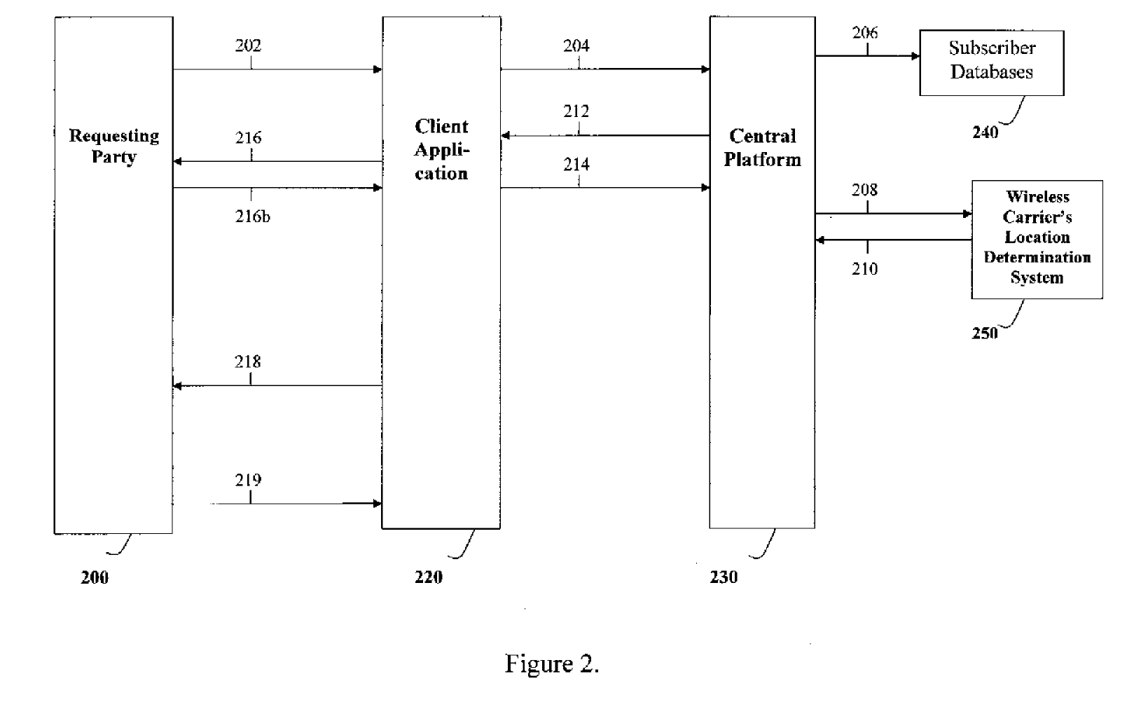

Referring to FIG. 2, in step 202 a requesting party 200 sends a search request to an organization's system, i.e. central platform 230, using client application 220. The requesting party 200 specifies members' characteristics in the request that makes these members appropriate targets for the requesting party 200. In one embodiment the requesting party 200 may specify that it is interested in members in a given location. The term “location” includes location at a moment in time, or as a pattern. In other embodiments, the requesting party may specify the member's location and at least one other characteristic.

Filing search requests over the network is well known in the art as demonstrated in, for example, U.S. Pat. No. 7,117,451. The requesting party will ordinarily choose certain target characteristics through drop down menus or may choose other requests through filling in appropriate times or keywords in the space provided on the interface.

Where the organization permits a requesting party to make a search request of its members that includes one or more location characteristics (such as home or billing location, real time location, or pattern of location), the client application 220 may allow the requesting party 200 to access a mapping function on the client application 220 through which it would identify the geographic area in which it is targeting members. A mapping function may allow the requesting party 200 to be served a map of an area or address that it has specified through the client application 220. The requesting party 200 then enters the specific geographic area of interest on the map. Software processes can convert actual addresses into a geographic point or area in order to prepare to perform a search request of members with, for example, such home addresses in area or in proximity to the area. Mapping functions are known in the art and may be obtained from, for example, MapQuest, Inc., of Denver, Co. or Google, Inc., of Mountain View, Calif.

Once the client application 220 has received the search request, the client application 220 sends the search request to the central platform 230, as represented by step 204. In step 206, the central platform 230 searches the Member Profiles which are stored in the database 240, which may be a local database or an external database, as explained above. Alternatively, information from the Member Profiles may be transmitted by the organization from the database 240 to the central platform 230 so that it is categorized or resorted in an easily searchable form.

In a preferred embodiment, where the organization is a wireless telecom carrier and the requesting party seeks to perform a search request of members in the area at a certain time (or routinely in the area), the client application may initiate a location determination process, as represented by step 208. The central platform 230 will receive the request from the client application 220 and may initiate the location determination process by transferring the request to the appropriate elements within the wireless carrier's location determination system 250. Steps 206 and 208 may be run simultaneously or sequentially and need not both be present.

Location detection technology which allows wireless telecom carriers to determine the real-time location of a member or series of members is well known in the art. For example, using Global Positioning System (GPS) technologies built into many new wireless devices, certain carriers may identify location to within four meters. GPS chip technology for integration into wireless handsets is available from, for example, Sirf Technologies, of San Jose, Calif., or Global Locate, of Glen Rock, N.J. Carriers using Global System for Mobile Communications service (GSM) networks have the capability to determine location to within 50 to 100 meters provided that they are able to triangulate the position using a technique called Time Differential of Arrival—or “TDOA”—which requires that at least three towers have a signal from the device; where only one or two towers have a signal, accuracy is more likely between 500 meters to 1.5 kilometers. GSM-based carriers and carriers relying on GPS commonly use a platform for location determination that is available from, for example, Openwave Systems, of Redwood City, Calif., AutoDesk, Inc., of San Rafael, Calif., or TruePosition, of Berwyn, Pa. GPS and GSM networks can also be used to determine speed and direction of a mobile device through several measurements occurring at timed intervals. The wireless carrier's location determination system 250 returns a list of members in the specific location to the central platform 230, in step 210.

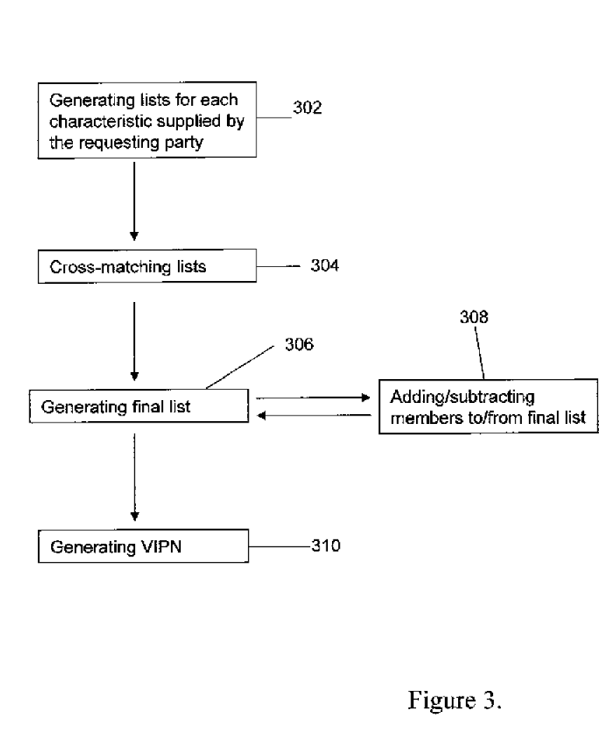

Next the central platform 230 prepares a response to the client's application 220 request received in step 204. This process is presented in FIG. 3. In step 302, the central platform generates target lists containing information related to members that match characteristics supplied by the requesting party 200 in step 202. These lists may include member profile target lists that are generated by searching for a certain characteristic stored in the Member Profiles. Alternatively, these lists may include a geographical target list which is produced by listing all members matching the geographical specifications of the requesting party. The lists may also include lists generated based on other specialized information in the organization's possession.

In step 304, if more than one characteristic is specified by the requesting party in step 202, the target lists may be cross-matched to generate a final target list of the members that match all characteristics specified by the requesting party in step 202. If only one characteristic is specified by the requesting party in step 302, the target list generated based on that characteristic simply becomes the final target list. Generation of the final list is represented by step 306.

In some embodiments, the requesting party may designate a maximum or minimum number of members that it wishes to target, as shown by optional step 308. If in the process the final target list contains fewer than the desired minimum number of members, the process may be repeated using secondary default characteristics to designate enough cross-matching members that are close to meeting the requesting party's original search request specifications or characteristics. If the final list contains more than the desired maximum number of members, the process may be repeated to remove members that do not match additional specifications or characteristics. The requesting party may choose to enter the secondary default specifications at the same time as the primary specifications, i.e. in step 202. Alternatively, the organization may request the secondary characteristics later in the process such as, for example, after the organization generates the final target list.

Once the final target list is generated in step 306, the central platform 230 replaces information about organization members in step 310 with an anonymous identifier. This step is performed by a Virtual Identity Protection System (“VIPS”). VIPS is a method which allows any organization to protect and effectively manage information about its members. It is employed at the organization central platform 230 before any information is returned to the client application 220. This step occurs regardless of whether the actual search request results are ever presented to the requesting party 200 through the client application 220. Here, the term “encryption” means any procedure to obscure information.

The VIPS process may preferably convert all information which might otherwise identify a household or an individual into a Virtual Identity Protection Number (“VIPN”). Other information related to members may be encrypted as well in some embodiments. A VIPN may be produced to represent each member matching the requesting party's search request specifications, and may preferably include, for example, an unspecified-length, random string or sequence of characters produced as a result of a randomizing algorithm, as will be described below. The characters may be random only in a part or in the full string, may be any length, and are produced through a randomization process known only to the organization. Each single VIPN assigned by the organization to each member allows the requesting party to uniquely refer to such member without knowing the identity of the member.

For security purposes, a single member may be assigned a different VIPN by an organization for each requesting party and for each project. The term “project” means a series of steps initiated by the requesting party filling out a request which are performed to satisfy the request as well as additional steps related to the same request. VIPNs may be produced to reflect or embed certain and specific selection criteria associated with the project. Preferably, a VIPN may also bear information related to the identity of the requesting party or of the project so that the numbers will be meaningless if attempted to be used by another party or in reference to another project. VIPNs need not have permanent association with a member and may be destroyed at the termination of a requesting party's project or after a certain date.

A VIPN may be generated using any known method in the art. VIPN may be generated in part or in full by encrypting member's identifying information. When generated in part, the other part of VIPN may preferably be constructed from the requestor's account ID or the requestor's project ID, so that the entire VIPN also identifies the associated requester or the project. Although VIPN may be as simple as a random number or even a first letter of the member's name, in the preferred embodiments, generating a VIPN is more complicated to ensure a high level of security. One suitable non-limiting example is provided below.

VIPNs, in part or in full, may be generated via an iterative formula which calculates the next VIPN based on the previous VIPN or based on the iteration number. For example, a sequence of numbers may start from a certain arbitrarily chosen number, and maybe incremented by another arbitrarily chosen number. VIPNs, in part or in full, may be generated as a random number using any of the existing random number generation methods such as CryptGenRandom, a random number generator function that is included in Microsoft's Cryptographic Application Programming Interface. A random number is then multiplied by an arbitrarily chosen coefficient in order to receive the final number. A generated number may optionally be further converted by swapping some bits with others, decided arbitrarily, in order to make it non-obvious how the full VIPN is generated (for example, bit 0 can be swapped with bit 45; bit 1 can be swapped with bit 27, etc). A generated number may optionally be further converted to a hexadecimal representation from decimal. Or it can be converted to an ASCII string of characters by mapping the value of every 2, 3, 4, 5, 6, or 7 bits (arbitrarily chosen) of the generated number into an arbitrarily chosen subset of ASCII characters. For example, mapping the value of every 5 bits (possible range 0-31: total of 32 numbers) of the generated number may be mapped into a subset of ASCII characters A-Z (excluding “I”, “J”, “O”, “Q”) and 0-9 (total of 32 characters) so that value 0 corresponds to “A”, value “1” corresponds to “B”, and so on, and at the end value 30 corresponds to “8”, and value 31 corresponds to “9”. Mapping can also be done via a table where correspondence of every number 0-31 to the 32 characters A-Z and 0-9 above is arbitrarily chosen.

In some embodiments, a Protected Name Equivalent (PNE) may be generated for each VIPN. PNEs may be randomly generated by a computerized algorithm with or without the use of the actual names publicly available through sources such as telephone directories. Preferably, the actual names of members are not used to generate corresponding PNEs. Also, it is preferable that PNEs may meet certain conditions whereby they include a pattern familiar to the language of the requesting party (i.e., in the US, first and last name), the names should not match any identifiable names. PNEs may be used by themselves or in combination with another random sequence. The requesting party can refer to organization members by using VIPNs, or by using PNEs.

Only the organization bearing the Member Profile possesses the algorithms necessary to convert the VIPN into any form of identifying information. Preferably, for security purposes, these algorithms are maintained at the central platform level 230 and separate from the client application 220. No other person or entity is able to convert VIPNs into identifying information. VIPNs may exist only for a specified time duration. At the end of a project, the VIPNs may be destroyed, i.e., deleted from the system, and are no longer recognized by the organization.

Referring back to FIG. 2, in step 212, VIPNs are returned from the central platform 230 to the client application 220. In some embodiments, the client application 220 may then direct to the central platform 230 that a message or promotional distribution be directed to the members represented by the VIPNs—through mail, email, text messaging, or other technologically possible means, in step 214. The message or promotional distribution may be supplied by the requesting party 200 at the time of entering the search request in step 202. Alternatively, the requesting party 200 may provide these materials in step 216b in response to a request 216a by the client application 220 after the list of VIPNs is returned. The organization may send the promotional materials to its members as described above in FIG. 2.

In another embodiment, the client application 220 may return the VIPNs to the requesting party 200, in step 218. Each VIPN may be returned with or without additional information which may include, but is not limited to, calling patterns, age, location at a given time, income, or hobbies. Preferably, the requesting party cannot identify the organization's members based on the additional information. If VIPNs are returned without non-identifying information, then each VIPN simply indicates to the requesting party the presence of a member meeting its search request specification.

After the target list is returned to the requesting party 200, the requesting party 200 may perform other tasks with the VIPNs in order to achieve its objective. Such tasks may include one or more additional search requests of the organization's Member Profiles as represented by step 219. It may then cross-match the results of its search requests in order to match, add to, or eliminate members from those targets lists it has received from prior search requests. The requesting party 200 may transfer advertisements or promotional materials to the member of the organization who is associated with such VIPN after reviewing the results of its search request or requests. Where the organization is a wireless telecom carrier, the requesting party may seek additional location information of the VIPNs that it has already been provided.

In one embodiment, a method, a system, and computer instructions are provided that allow organizations to share information in their possession. These organizations may possess the same data and, preferably, the data is stored in the same format, or is convertible to compatible format. First, a first organization generates first hashed information by utilizing a one-way encryption key to hash some information in its possession. The first organization can then share the one-way key with other organizations. These organizations generate second hashed information using the one-way encryption key. The first and the second hashed information are then compared to determine whether the organizations possess any common information.

Although this method may be suitable in any situation where organizations may desire to gather information from different organizations, supplement information in their possession, or to determine whether various organizations have the same information, it will be discussed in reference to a specific but non-limiting example. This method allows a single requesting party to obtain and use the cross-referenced results of search requests made across two or more separate and distinct organizations. This embodiment is referred to as a VIPS cross-referencing process. The VIPS cross-referencing process enables a requesting party to gain additional, specialized knowledge about members of two or more organizations than could be obtained through an independent search request of only a single organization's data. The requesting party may use the results of a VIPS cross-referencing process to build target lists of VIPNs representing members associated with characteristics that can only be identified through multiple organizations. Using VIPS cross-referencing the requesting party would receive results that meet several different search parameters that may not all be known by a single organization, thus greatly enhancing the breadth of information that it could have received from a single organization independently.

By way of a non-limiting example, Organization A could be a wireless carrier with searchable profile characteristics such as real time location, place of residence, place of work, age range, sex, or annual income range. Examples of Organization B could be, but are not limited to, a credit card company with searchable profile characteristics such as a credit card balance range as of the last billing statement, or an average balance range for a given period; a bank with searchable profile characteristics such as checking/savings/combined account balance range, outstanding loans balance range; a power utility with searchable profile characteristics such as the recent/average energy bill amount range; a department of motor vehicles with searchable profile characteristics such as type of vehicle owned, make year range, or violations points range.

Cross-referencing is preferably performed in a manner to guarantee that no organization or other party discloses identifying information to the requesting party, or to any other party, and that no organization gains any confidential information about another organization's members or learns any additional and confidential information about its own members.

In order to perform a cross-referencing process involving two separate organizations, Organization may agree to apply a series of sequential codes to its results. These codes may be presented to it in the form of a one-way encryption key together with a unique reference number by which the key can be delivered to it by another Organization or by a cross-reference server, as illustrated below.

Typically, VIPN cross-referencing can be facilitated through one organization sharing with another organization an one-way encryption key containing the parameters for the algorithm necessary to produce a corresponding series of sequential codes from the application of the search for the requesting party. The requesting party receives two lists of VIPNs—one from Organization A (which matches profile A characteristics) and another from Organization B (which matches profile B characteristics). Since VIPNs are generated using the same algorithm, this cross-referencing process allows finding those VIPNs from Organization A that match VIPNs from Organization B.

However, it is recognized that this process may have certain security limitations and therefore an expanded, more secure cross-referencing process may be preferable. In such embodiments, this process may rely on a cross-reference server that is preferably hosted and managed by an independent party, i.e. a party which is neither the requesting party nor an organization of which a search request is being made. The cross-reference server may provide minimum direct interaction between organizations (as they are non-cooperating entities and may be prohibited by law, by public policy concerns or by their own internal directives from sharing information concerning their members with one another). It may also provide the requesting party with the ability to make a single search request with the combined profile requirements (part of which belongs to Organization A and part to Organization B, or other organizations) thus making the entire cross-referencing functionality transparent to the requesting party, while at the same time providing computing power and networking connectivity to perform cross-referencing.

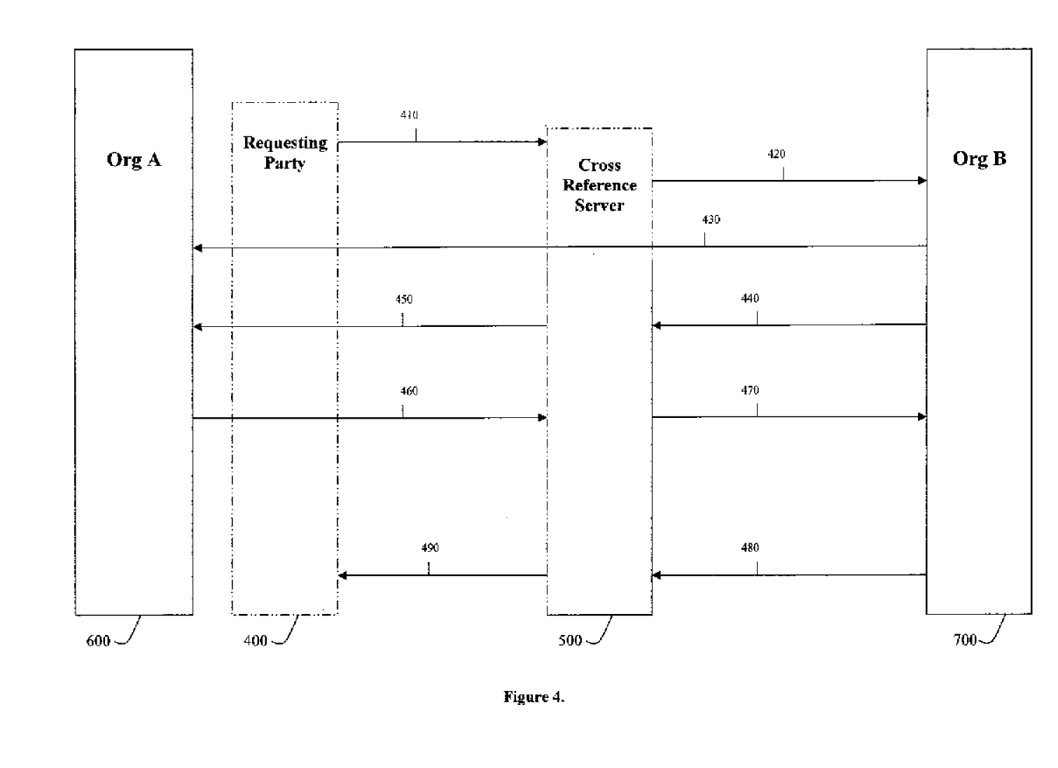

FIG. 4 illustrates the flow of requests in a VIPS cross-referencing process. For simplicity, the process is demonstrated with only two organizations, Organization A and B. The process is equally suitable to cases with more than two organizations. Furthermore, a person with ordinary skill in the art will undoubtedly realize that in various embodiments the steps described below may be eliminated, combined, repeated or performed in different order or by different parties.

In step 410, a requesting party 400 issues a Main Request to a cross-reference server 500. Alternatively, the request can be made to organization A 600 or Organization B 700 that may transmit the request to the cross-reference server 500. The main request may direct the cross-reference server 500 to test whether a member of organization A 600 (identified by a VIPN A previously received from Organization A as described above) is also a member of Organization B or whether characteristics of a member known by organization A match profile characteristics known about this member by organization B 700. Alternatively, the request may seek all non-identifying profile characteristics about this member known by organization B 700. Both requested characteristics, and characteristics returned can be exact or represented as ranges—for convenience and security purposes. As with a simple single organization VIPS search illustrated in FIG. 3, the requesting party 400 may be provided a VIPN corresponding to a member, may be provided with detailed profile characteristics for the member associated with the VIPN in addition, or both.

In step 420, the cross-reference server 500 sends a message to Organization B 700 requesting Organization B 700 to send its one-way encryption key, containing the parameter algorithms that it will supply to Organization A 600, together with a unique reference number, reference number B, by which the key can be later identified. Organization B 700 may use the same one-way encryption key to generate first hashed information related to its members. Although in the preferred embodiments identifying information is hashed, depending on the type of one-way encryption key, the information related to members may also non-identifying information.

Algorithms for generation of one-way encryption keys are well known in the art and include, for example, MD5 and Secure Hash Standard (SHA-1), among many others. Preferably, MD5, which is defined in the Request For Comments (RFC) document number 1321, is used. MD5 takes as input a message of arbitrary length and produces as output a 128-bit “fingerprint” or “message digest” of the input. It is conjectured that it is computationally infeasible to produce two messages having the same message digest, or to produce any message having a given pre-specified target message digest. If two different messages produce the same “message digest”, a different one-way encryption key can be used for those two messages as is described below.

Next, in step 430, Organization B 700 sends its one-way encryption key and reference number B directly to Organization A 600. Organization A 600 stores both the one-way encryption key and the reference number B and is able to find the key if given a unique corresponding reference number. In some embodiments, Organization B may also include the first hashed information. Where Organization A and B are prohibited by law, by public policy or by their own internal rules from any contact whatsoever, an additional party (server) that is independent of both and of the cross-reference server 500 may preferably facilitate this communication.

Organization B 700 also sends reference number B only (without the key) to the cross reference server 500, in step 440. The cross-reference server 500 sends a message to Organization A 600 in step 450. In this message, the cross reference server 500 may request from Organization A 600, using one-way encryption, to hash information associated with VIPN A with the key corresponding to the reference number B.

Using the reference number B, Organization A 600 finds the one-way encryption key, and hashes information related to the member associated with VIPN A, i.e. generates second encrypted information. Such information may be identifying information, non-identifying information or both. In the preferred embodiments, only identifying information is hashed. In step 460, Organization A 600 sends hashed information for VIPN A to the cross-reference server 500. The cross-reference server 500 then sends a message to Organization B 700 requesting Organization B 700 to check whether it has a Member for the given encryption and the reference number, as represented by step 470. Organization B 700 finds the one-way encryption key based on the reference number, and searches its table of encryptions (based on that key) of all members.

In step 480, consistent with the Main Request in step 410 above, Organization B 700 sends to the cross-reference server 500 a message that may indicate, for example, that Organization B 700 (a) does not have such member; (b) has such member; (c) has such member, but characteristics do not match; (d) has such member and characteristics match. Where non-identifying profile characteristics are requested, Organization B 700 may indicate that it (a) does not have such Member, or (b) has such Member, and this is the full list of non-identifying profile characteristics. As noted above, preferably Organization B 700 only supplies all non-identifying profile characteristics where it has satisfied itself that doing such would not reasonably risk allowing the requesting party to determine the identity of the VIPN. Finally in step 490, depending on the message received from Organization B in step 480, the cross-reference server 500 sends the main response to the requesting party 400.

Organization B may maintain or change a one-way encryption key (known to Organization B only) as often as it wants, and may apply this one-way encryption key to produce encryptions of identifying information for all its members. In some case it may be preferable for an organization to maintain several one-way encryption keys at the same time. For example, after Organization B receives information from organization A hashed by a one-way encryption key supplied by organization B, Organization B compares its hashed information with received information, as described above. If Organization B finds matching hashed information among all its hashed information for similar fields of identifying information for all its members, then such matching hashed information identifies a Member who matches the Member from Organization A. Should Organization B find more than one identical hashed information, then Organization B may switch to another one-way encryption key and repeat the process for a given VIPN so that a unique Member can be found among those with the same encryption.

A system 400 suitable for carrying out methods disclosed above is presented in FIG. 4. Such a system comprises a bus 402, a memory device 404 connected to the bus 402, a processor 406 connected to the bus 402, and I/O interface 408 connected to the bus 402 for connecting the system 400 to external devices. The memory device 404 may be an external or internal memory device such as RAM, ROM, Hard Drive, CD-ROM, or DVDs. The memory device 404 may store information related to members. It may also store computer-readable instruction for the processor 406 to execute the steps of the methods described above. The instructions may be written in any known programming language and converted to a language readable by system 400. Through the I/O interface 408, the system 400 may be connected to external devices 410 which include, but are not limited to, a keyboard, a mouse, a display, a communication networks 412. Suitable communication networks 412 include, but are not limited to, LAN, WAN, the Internet, or wireless networks among others. Through the I/O interface 408, and further through communications networks 412, the system 400 may be connected to network attached storage systems 416 residing elsewhere on the network or other systems 414 residing elsewhere on the network.

All publications cited in the specification, both patent publications and non-patent publications, are indicative of the level of skill of those skilled in the art to which this invention pertains. All of these publications are herein fully incorporated by reference to the same extent as if each individual publication were specifically and individually indicated as being incorporated by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A computer implemented method for sharing or presenting information regarding members comprising:
receiving a request from a requesting party wherein the requesting party specifies at least one characteristic in the request;
generating a list of members that match the at least one specified characteristic in response to the request;
substituting information related to members on the list with an anonymous identifier; and
providing the anonymous identifier to the requesting party.

2. The computer implemented method of claim 1 wherein the anonymous identifier comprises an unique anonymous identifier.

3. The computer implemented method of claim 1 further comprising receiving instructions to perform an action associated with at least some members on the list.

4. The computer implemented method of claim 1 further comprising destroying the encrypted information after the requesting party indicates that a project is over or after set time period.

5. The computer implemented method of claim 1, wherein the at least one specified characteristic comprises a location.

6. The computer implemented method of claim 1, wherein the at least one specified characteristic comprises a location and at least one other characteristic and wherein the step of generating a list of members that match the specified characteristic in response to the request comprise:
generating a list of members that match the location specified by the requesting party;
generating a list of members based on each of at least one other characteristic specified by the requesting party; and
intersecting the lists generated based on the location and the at least one other characteristics.

7. The computer implemented method of claim 1 further comprising:
generating a list comprising a plurality of random last names and random first names wherein the number of random last names and the number of random first names equals the number of the members on the list; and
replacing or supplementing encrypted information with one random last name and one random first name wherein a unique pair of random last name and random first name are only used once.

8. The computer implemented method of claim 1, further comprising:
receiving a one-way encryption key;
applying the one-way encryption key to hash information related to at least some of the members on the list; and
causing the requesting party to receive the hashed information.

9. The computer implemented method of claim 1, further comprising:
receiving a one-way encryption key and first hashed information;
applying the one-way encryption key to generate second hashed information related to at least some of the members on the list; and
intersecting the first hashed information and the second hashed information;
causing the requesting party to receive information related to members included into the first hashed information and the second hashed information.

10. A system for sharing or presenting information regarding members comprising a bus system; a memory connected to the bus system wherein the memory includes a set of instructions; and a processor connected to the bus system, wherein the processor executes the set of instructions stored in memory to:
receive a request from a requesting party wherein the requesting party specifies at least one characteristic in the request;
generate a list of members that match the at least one specified characteristic in response to the request;
substitute information related to members on the list with an anonymous identifier; and
provide the anonymous identifier to the requesting party.

11. The system of claim 10 wherein the processor further executes the set of instructions to receive instructions to perform an action associated with at least some members on the list.

12. The system of claim 10 wherein the processor further executes the set of instructions to destroy the encrypted information after the requesting party indicates that a project is over or after set time period.

13. The system of claim 10 wherein the at least one specified characteristic comprises a location and at least one other characteristic and wherein the set of instruction to generate a list of members that match the specified characteristic in response to the request comprises instructions to:
generate a list of members that match member's location specified by the requesting party;
generate a list of members based on each of at least one other characteristics specified by the requesting party; and
match the lists generated based on members' location and members other characteristics

14. The system of claim 10, wherein the processor further executes the set of instructions to:
generate a list comprising a plurality of random last names and random first names wherein the number of random last names and the number of random first names equals to the number of the members on the list;
replace or supplement encrypted information with one random last name and one random first name wherein a unique pair of random last name and each random first name are only used once.

15. A computer-readable medium having computer instructions, which when executed, carry out a method for sharing or presenting information regarding members, the method comprising:
receiving a request from a requesting party wherein the requesting party specifies at least one characteristic in the request;
generating a list of members that match the at least one specified characteristic in response to the request;
substituting information related to members on the list with an anonymous identifier; and
providing the anonymous identifier to the requesting party.

16. The computer-readable medium of claim 15, wherein the anonymous identifier comprises an unique anonymous identifier.

17. The computer-readable medium of claim 15, wherein the method further comprises receiving instructions to perform an action associated with at least some members on the list.

18. The computer-readable medium of claim 15, wherein the method further comprises destroying the encrypted information after the requesting party indicates that a project is over or after set time period.

19. The computer-readable medium of claim 15, wherein the at least one specified characteristic comprises a location.

20. The computer-readable medium of claim 15, wherein the at least one specified characteristic comprises a location and at least one other characteristic and wherein the step of generating a list of members that match the specified characteristic in response to the request comprise:
generating a list of members that match member's location specified by the requesting party;
generating a list of members based on each of at least one other characteristics specified by the requesting party; and
matching the lists generated based on members' location and members other characteristics.

21. The computer-readable medium of claim 15, wherein the method further comprises:
generating a list comprising a plurality of random last names and random first names wherein the number of random last names and the number of random first names equals to the number of the members on the list;
replacing or supplementing encrypted information with one random last name and one random first name wherein a unique pair of random last name and each random first name are only used once.

22. The computer-readable medium of claim 15, wherein the method further comprises:
receiving a one-way encryption key;
applying the one-way encryption key to hash information related to at least some of the members on the list.

23. A method for sharing or verifying information between a first organization and at least one second organization each having at least one member, the method comprising:
first organization generating a first encrypted information utilizing a one-way encryption key;
first organization sharing the one-way key with at least one second organization;
at least one second organization generating at least one second encrypted information utilizing the one-way encryption key; and
comparing the first encrypted information and at least one second encrypted information.

24. A system for sharing information regarding members comprising a bus system; a memory connected to the bus system wherein the memory includes a set of instructions; and a processor connected to the bus system, wherein the processor executes the set of instructions stored in memory to perform the step of the method of claim 23.

25. A computer-readable medium having computer instructions, which when executed, carry out a method of claim 23.
